(19) United States
(12) Patent Application Publication
(10) Pub. No.: US 2014/0067639 A1
(43) Pub. Date: Mar. 6, 2014

(54) CREATION AND TRADING OF FLOATING-RATE EXCHANGEABLE TREASURY INSTRUMENTS

(71) Applicant: Richard K. MacWILLIAMS, New Orleans, LA (US)

(72) Inventor: Richard K. MacWILLIAMS, New Orleans, LA (US)

(73) Assignee: eBond Advisors LLC, New York, NY (US)

(21) Appl. No.: 13/602,808

(22) Filed: Sep. 4, 2012

(51) Int. Cl. G06Q 40/04

(52) U.S. Cl. 705/37

(57) ABSTRACT

Rather than issuing floating rate debt obligations, techniques are described for allowing a sovereign debt issuer, such as the United States Treasury, to issue novel exchangeable fixed rate debt instruments. A system, method, and computer program product are provided for exchanging the fixed rate exchangeable sovereign debt instruments for floating rate exchangeable sovereign debt instruments in combination with negotiation of an interest rate swap contract.

### CROSS-REFERENCE TO RELATED APPLICATIONS

The present application is related to U.S. patent application Ser. No. 12/703,073, filed Feb. 9, 2010, to U.S. patent application Ser. No. 12/839,218, filed Jul. 19, 2010, and to U.S. patent application Ser. No. 13/295,420, filed Nov. 14, 2011, all of which are incorporated by reference herein in their entireties.

### BACKGROUND

1. Field

Embodiments of the present invention relate generally to investment vehicles, and, more particularly, to floating-rate exchangeable treasury instruments.

2. Background

A critical deficiency of the U.S. Treasury market is the lack of standard floating rate securities. This deficiency is found in debt issued by any sovereign. While there is significant market demand for such securities, the Treasury is reluctant for many reasons to issue floating rate obligations.

Accordingly, what is desired is a technique to offer floating rate treasuries without affecting existing fixed rate treasury debt issuance approaches.

### SUMMARY

Methods, systems, and computer program products are provided for receiving, by one or more computing devices, a floating rate exchangeable sovereign debt instrument from a sovereign in exchange for delivering a fixed rate exchangeable sovereign debt instrument to the sovereign, wherein the sovereign agrees to make floating rate interest payments to the holder of the floating rate exchangeable sovereign debt instrument and contracting an interest rate swap with the sovereign, comprising an agreement to pay to the sovereign the floating rate interest payments of the floating rate exchangeable sovereign debt instrument and to receive from the sovereign fixed rate interest payments of the fixed rate exchangeable sovereign debt instrument.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 is a diagram illustrating an eUST marketplace, in accordance with an embodiment of the present invention.

FIG. 2 illustrates the process for agreeing to an interest rate swap in an eUST marketplace, in accordance with an embodiment of the present invention.

FIG. 3 illustrates a flow diagram for the contracting of an interest rate swap agreement between a dealer and a sovereign, such as the U.S. Treasury, in accordance with an embodiment of the present invention.

FIG. 4 illustrates a flow diagram for performing an eUST exchange, in accordance with an embodiment of the present invention.

FIG. 5 illustrates a flow diagram illustrating a clearing process, in accordance with an embodiment of the present invention.

FIG. 6 illustrates a flow diagram of a full transaction, in accordance with an embodiment of the present invention.

FIG. 7 depicts an example computer system in which embodiments of the present invention may be implemented.

Embodiments of the present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### I. Introduction

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, and within the scope and spirit of the present invention.

Reference to modules in this specification and the claims means any combination of hardware or software components for performing the indicated function. A module need not be a rigidly defined entity, such that several modules may overlap hardware and software components in functionality. For example, a software module may refer to a single line of code within a procedure, the procedure itself being a separate module. One skilled in the relevant arts will understand that the functionality of modules may be defined in accordance with a number of stylistic or performance-optimizing techniques, for example.

In the United States, the sovereign federal government issues debt through the

United States Treasury, typically in the form of notes and bonds. The Federal Reserve Bank of New York normally acts as the issuing and payment agent for the U.S. Treasury. Historically, these obligations have been fixed rate debt instruments, and the Treasury has been reluctant to issue floating rate obligations for a number of reasons. While the discussion in this disclosure uses terminology generally applicable to the United States Treasury and its issued obligations, one skilled in the relevant arts will appreciate that these techniques can be applied to other sovereign or sovereign-like debt issuers. One skilled in the relevant arts will appreciate that while examples are provided using the U.S. Treasury, other sovereign debt issuers can be substituted and applicability to the U.S. Treasury is provided by way of example, and not limitation.

In order to avoid the need to restructure the Treasury's debt-issuance approach and engage in the higher risk associated with floating rate treasury instruments, a new debt instrument is developed that allows the sovereign to continue issuing fixed rate obligations while allowing the market to transform these securities into standard floating rate debt.

In accordance with an embodiment of the present invention, the new instrument is termed an “exchangeable U.S. Treasury” or “exchangeable Treasury note” (“eUST”), although one skilled in the relevant arts will again understand that this approach can be utilized outside of the context of the United States federal government.

The U.S. Treasury faces a challenge in meeting the demand for floating rate U.S.

Treasury securities, which carry an inherent risk to the issuer. The proposed technique allows the U.S. Treasury to meet this demand without shifting the interest rate risk to the American taxpayer. In addition to providing a market-driven solution for floating rate U.S. Treasury securities, the proposed eUST approach also provides an opportunity for the government to participate in and endorse the Dodd-Frank mandated use of a counterparty clearing organization or clearinghouse, commonly referred to as a CCP. Leadership by the U.S. Treasury through its participation in the clearing process will help regulators meet their goal of moving as much over-the-counter (“OTC”) derivative clearing through CCPs as possible.

Fixed rate eUSTs operate in a similar manner to existing U.S. Treasury debt in virtually all respects. However, this new investment instrument includes an addition to the bond structure that provides for its exchangeability into related floating rate debt (floating rate eUSTs) and vice versa. The conversion of fixed to floating is accomplished by linking fixed rate eUSTs to matching interest rates swaps (“IRS”) cleared by a CCP, in accordance with an embodiment of the present invention.

Under the eUST structure, the Treasury continues to be the obligor of both fixed and floating rate payments as well as principal payments to investors, but shifts its floating rate exposure to the IRS counterparty who has executed the eUST exchange. In practice each fixed rate eUST has a companion floating rate eUST. The two related bonds have the same maturity date, but different CUSIPs and different coupon types, in accordance with an embodiment of the present invention. This approach allows the Treasury to continue to make fixed interest payments while allowing investors to receive floating rate payments if they choose.

### II. Interest Rate Swaps

Interest Rate Swaps represent the largest financial derivative market in the world. Over $600 trillion are in existence today, including over $300 trillion cleared by SWAPCLEAR of the LCH.CLEARNET GROUP LTD. of the United Kingdom. In a “vanilla” IRS one party agrees to pay a fixed interest rate (the “swap rate”) for a specified term and receive a floating rate for the same term. The floating rate will typically be specified by use of a benchmark, such as the London Interbank Offered Rate (“LIBOR”), for a specified period of time (e.g., a 90-day LIBOR, specifying the computed average interest rate associated with a 90-day deposit).

Conversely, the swap counterparty agrees to receive a fixed rate of interest for a specified term and pay a floating rate for the same term. Most vanilla IRS trades are submitted to CCPs, SWAPCLEAR being the largest, who act in their margining and credit novation capacity.

CCP margining allows the parties to the swap to maintain a balance in the event of changes in the swap rate. In the event the swap rate increases from the originally traded level or the prior day closing price, the party receiving fixed rate payments is required to post margin equal to the present value of the rate change, in accordance with an embodiment of the present invention. Conversely, if the swap rate falls below the originally traded level or previous close price, the party paying the fixed rate is required to post cash margin, in accordance with a further embodiment of the present invention.

III. eUST Exchange Process

eUSTs are issued in the usual manner by the U.S. Treasury as with any other fixed rate obligation traditionally issued, in accordance with an embodiment of the present invention. They have fixed rate coupons, and maturity dates as specified by the U.S. reasury, such as maturity dates out to 30 years. However, in contrast to traditional fixed rate obligations issued by the U.S. Treasury, eUST instruments incorporate an exchange feature allowing the marketplace (e.g., primary dealers) to exchange fixed rate eUSTs for related floating rate eUSTs. The exchange itself can be handled, for example, by the U.S Treasury or by the Federal Reserve Bank on behalf of the U.S. Treasury, in accordance with an embodiment of the present invention. To execute the exchange, the exchanging dealer agrees to receive fixed rate payments from the U.S. Treasury based on the eUST coupon, and to return floating rate LIBOR payments to the U.S. Treasury. The net result of this operation is that the U.S. Treasury only pays out its traditional fixed rate obligations.

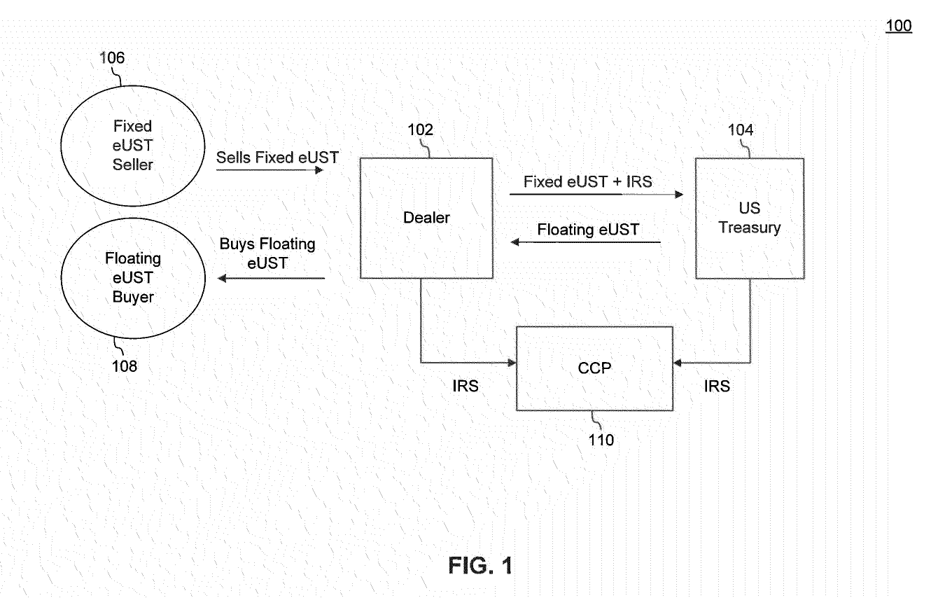

FIG. 1 is a diagram illustrating the eUST marketplace 100, in accordance with an embodiment of the present invention. Marketplace 100 includes a dealer 102 and a sovereign, such as the U.S. Treasury 104, in accordance with an embodiment of the present invention. In accordance with a further embodiment of the present invention, a CCP 110 is used as the counterparty to both dealer 102 and U.S. Treasury 104 for IRS transactions. Marketplace 100 also includes a seller 106 of fixed rate eUST instruments and a buyer 108 of floating rate eUST instruments.

By way of non-limiting example, an eUST 10-year fixed rate note can be exchanged for a related 10-year floating rate note. As shown in FIG. 1, dealer 102 may purchase a fixed rate eUST from seller 106, in accordance with an embodiment of the present invention. This fixed rate eUST can be exchanged with U.S. Treasury 104, provided that the dealer arranges for a 10-year IRS with the Treasury based on the underlying fixed rate coupon of the fixed rate eUST, in accordance with an embodiment of the present invention. In return, the U.S. Treasury can provide a floating rate eUST instrument, which the dealer 102 can then sell (e.g., to floating rate eUST buyer 108).

This IRS is agreed to by dealer 102 and U.S. Treasury 104, and then novated to CCP 110, in accordance with an embodiment of the present invention. By this novation, CCP 110 becomes a counterparty to both dealer 102 and U.S. Treasury 104, assuming the respective counterparty risks. Based on this role, CCP 110 is shown between dealer 102 and U.S. Treasury 104 as a counterparty to both.

One skilled in the relevant arts will appreciate that the various transactions disclosed herein can be performed through the use of one or more computing devices, an exemplary architecture of which is described in further detail below. In an example embodiment, one or more computing devices operated by dealer 102 are used to trade eUST instruments with seller 106 and buyer 108. Additionally, one or more computing devices operated by dealer 102 are used to exchange the fixed rate eUST and the floating rate eUST with sovereign 104, in communication with one or more computing devices operated by sovereign 104. Similarly, one or more computing devices operated by dealer 102 are used to novate the IRS to CCP 110, and sovereign 104 may similarly operate one or more computing devices for this purpose. CCP 110 may also operate one or more computing devices to arrange novation of the IRS. In accordance with a further embodiment of the present invention, one or more intermediary computing devices can be used in the transactions disclosed herein.

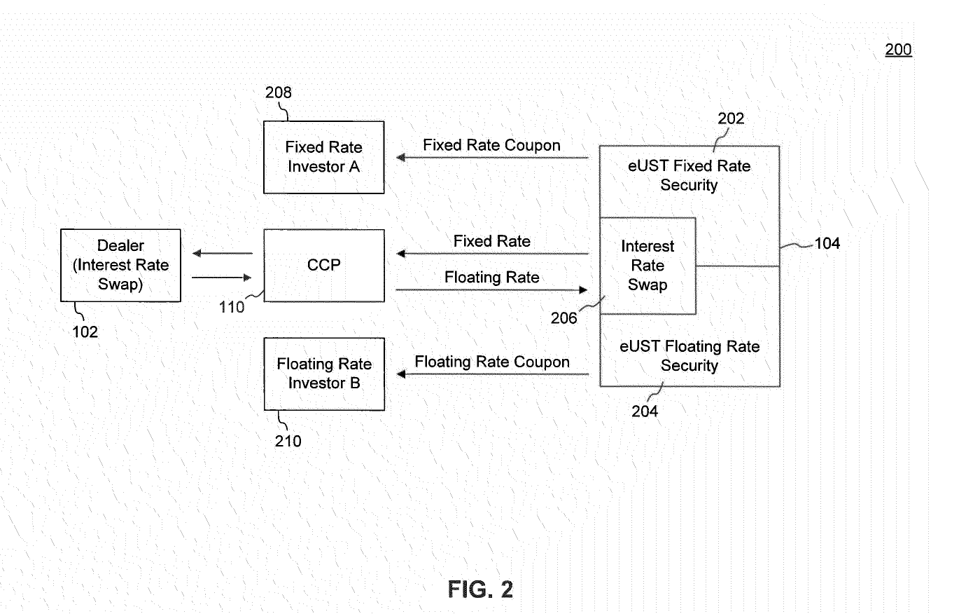

Since the actual swap rate is likely to be different from the eUST fixed coupon rate, upfront payments are used to equate the swap rate and the coupon rate, in accordance with an embodiment of the present invention. FIG. 2 illustrates the process for agreeing to an IRS in eUST marketplace 200, in accordance with an embodiment of the present invention. As previously described, U.S. Treasury 104 and dealer 102 agree to an IRS 206, which both parties then novate to CCP 110. Additionally, marketplace 200 illustrates the operation of a fixed rate eUST security 202, where U.S. Treasury 104 makes fixed rate coupon payments to fixed rate investor 208 in a manner consistent with existing fixed rate U.S. Treasury obligations.

When a fixed rate eUST 202 is exchanged for a floating rate eUST 204, the amount outstanding of the fixed eUST is reduced and the amount of the floating eUST is increased and vice versa. Hence the total amount outstanding between the two CUSIPS remains constant. Although the U.S. Treasury is making floating rate payments to floating rate eUST investors 210, the actual net cost to the U.S. Treasury remains fixed since the U.S. Treasury pays the fixed coupon rate to the IRS 206 counterparty (e.g., dealer 102, through CCP 110) and receives the floating rate, which can be used to pay the floating rate coupon to floating rate eUST investor 210. One skilled in the relevant arts will appreciate that the flows depicted in marketplaces 100 and 200 of FIGS. 1 and 2 are exemplary non-limiting flows, and will discern alternative flows contemplated within the scope of this disclosure.

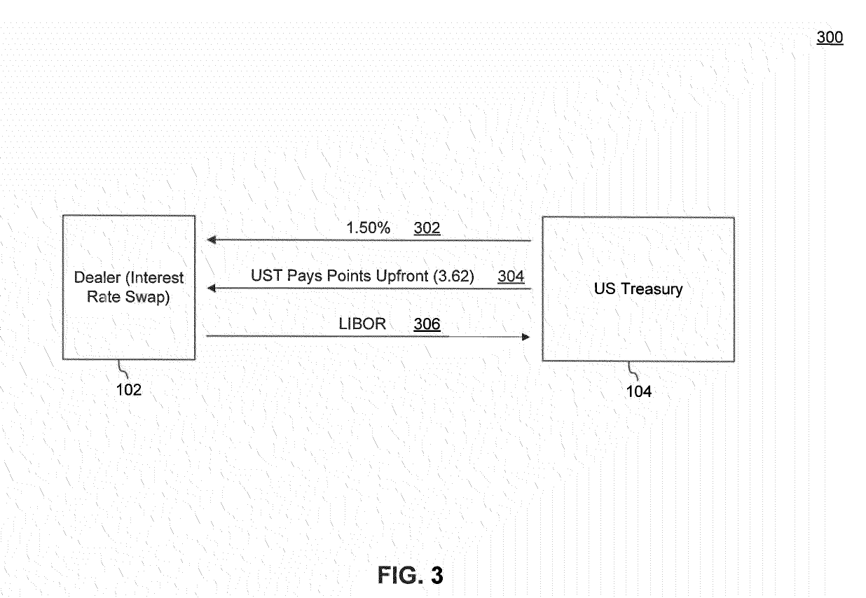

By way of non-limiting example, an actual eUST exchange may take on the form presented in FIGS. 3, 4, and 5. FIG. 3 illustrates a flow diagram 300 for the contracting of an interest rate swap agreement between dealer 102 and a sovereign 104, such as the U.S. Treasury, in accordance with an embodiment of the present invention. In this non-limiting example, dealer 102 and U.S. Treasury 104 agree to an IRS whereby the U.S. Treasury 104 will pay a coupon rate of 1.50% at step 302. Additionally, dealer 102 agrees to pay the U.S. Treasury 104 the LIBOR benchmark rate at step 306. However, in order to correct an imbalance in the swap rate, the U.S. Treasury 104 also agrees at step 304 to pay 3.62 points (40 basis points) up front to equal a swap rate of 1.90%. By agreeing to these terms, the U.S. Treasury forms a fixed rate U.S. Treasury instrument with the exchangeability property that allows it, as a fixed rate eUST, to be exchanged for a floating rate eUST.

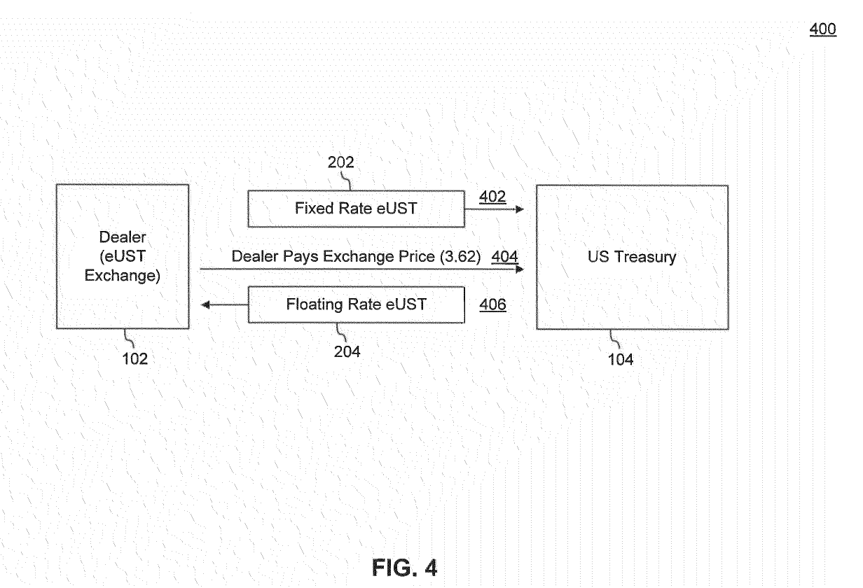

FIG. 4 illustrates a flow diagram 400 for performing the eUST exchange, in accordance with an embodiment of the present invention. At step 402, the dealer 102 tenders the fixed rate eUST 202 to U.S. Treasury 104, in accordance with an embodiment of the present invention. The dealer 102 receives the floating rate eUST 204 from the U.S. Treasury 104 at step 406. Note that in this non-limiting example, the dealer pays the exchange price of 3.62 points at step 404 to the U.S. Treasury 104. However the dealer also now holds a floating rate eUST 204 that is worth 3.62 points more than the fixed rate eUST 202 that was exchanged. So in order for this exchange to be economically attractive, the dealer must sell the floating rate eUST 204 at a price that is at least 3.62 points higher than the cost of the companion fixed rate eUST 202.

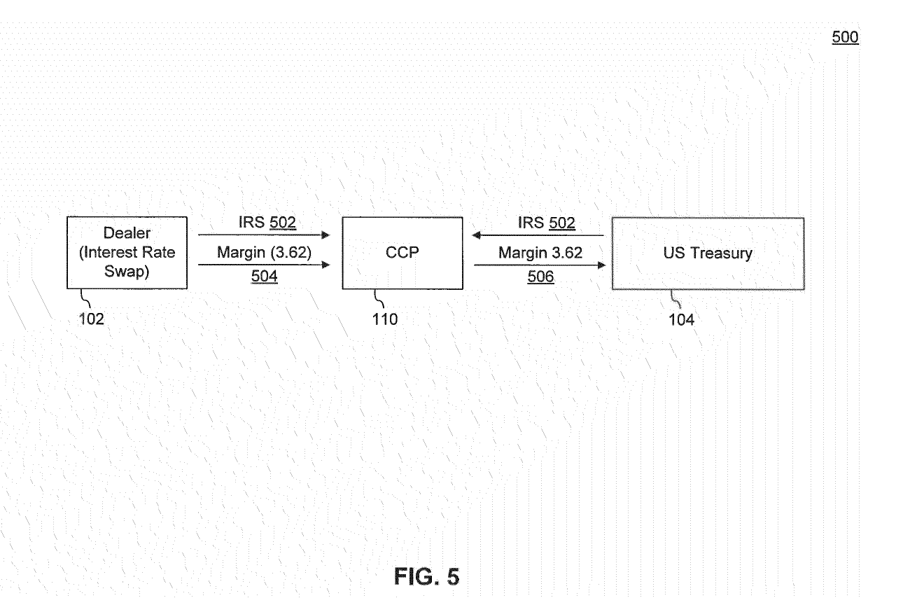

FIG. 5 illustrates a flow diagram 500 illustrating the clearing process, in accordance with an embodiment of the present invention. In accordance with an embodiment of the present invention, the U.S. Treasury 104 and dealer 102 submit the IRS to the CCP 110 at step 502. At this stage, and continuing the above non-limiting example, the dealer 102 has a 1.50% fixed rate swap with a market value of 1.90%, leaving a variation margin requirement of 3.62 points (40 bps). As shown at step 504, the dealer 102 must post a margin of 3.62 points with the CCP, leaving the U.S. Treasury with a positive margin balance of 3.62 points as shown in step 506. In accordance with an embodiment of the present invention, the positive margin balance is held by CCP 110.

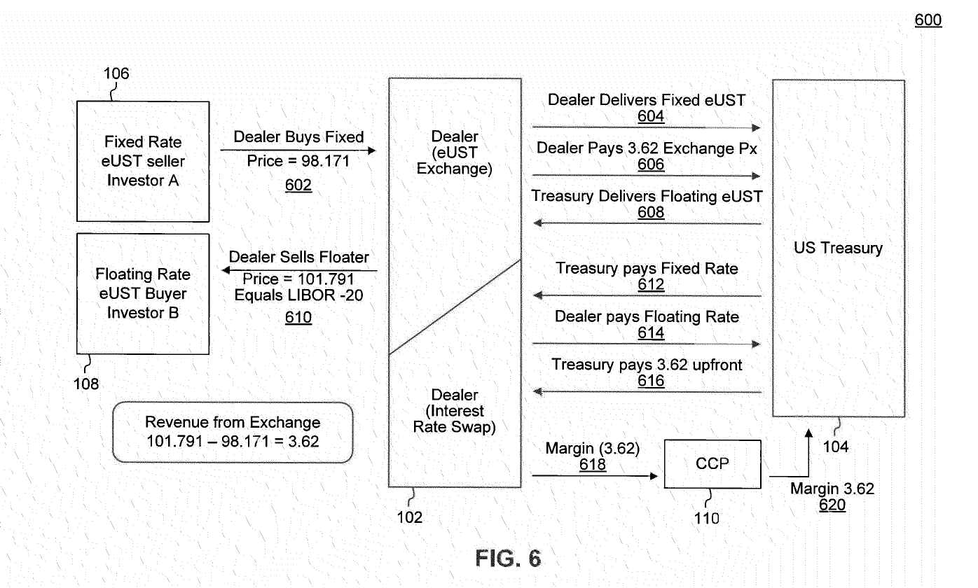

FIG. 6 illustrates a flow diagram 600 of the full transaction, in accordance with an embodiment of the present invention. As shown in FIG. 6, dealer 102 buys a fixed rate eUST (1.50% 10-year) at 98.171 to yield 1.70% from investor 106 at step 602, and is selling a floating rate eUST (LIBOR flat 10-year) at 101.791 to yield LIBOR minus 20 bps to investor 108 at step 610, The transaction is facilitated by the dealer exchanging the fixed rate eUST for the companion floating rate eUST with the Treasury and entering into an interest rate swap, agreeing to receive fixed @1.50% and pay floating @ LIBOR fiat.

In this non-limiting example, the dealer 102 delivers the fixed rate eUST at step 604 and pays 3.62 points as the exchange price at step 606 in order to receive a floating rate eUST from the U.S. Treasury 104 at step 608. Additionally, the dealer 102 and U.S. Treasury 104 agree to an IRS at steps 612, 614, and 616, in accordance with an embodiment of the present invention. In particular, at step 612, the U.S. Treasury agrees to pay a fixed rate (e.g., 1.50%) and the dealer agrees to pay the floating rate (LIBOR flat) at step 614. The U.S. Treasury additionally agrees to pay 3.62 points upfront at step 616 in order to equal the swap rate of 1.90%. All the transactional cash flows net out to zero with the dealer posting variation margin equal to the price difference between the fixed eUST and the floating eUST at step 618, leaving the U.S. Treasury with a positive margin balance of 3.62 at step 620, which is held by the CCP 110 in accordance with an embodiment of the present invention.

In the aforementioned non-limiting example, the spread between the swap rate and the market yield of the fixed eUST is 20 bps (1.90%-1.70%). Therefore, the breakeven yield on the floating rate eUST is LIBOR minus 20 bps. Additionally, the spread between the swap rate and coupon on the fixed rate eUST is 40 bps (1.90%-1.50%). Therefore, the exchange price and the upfront IRS payment is 40 bps (3.62 points).

### IV. Example Computer System Implementation

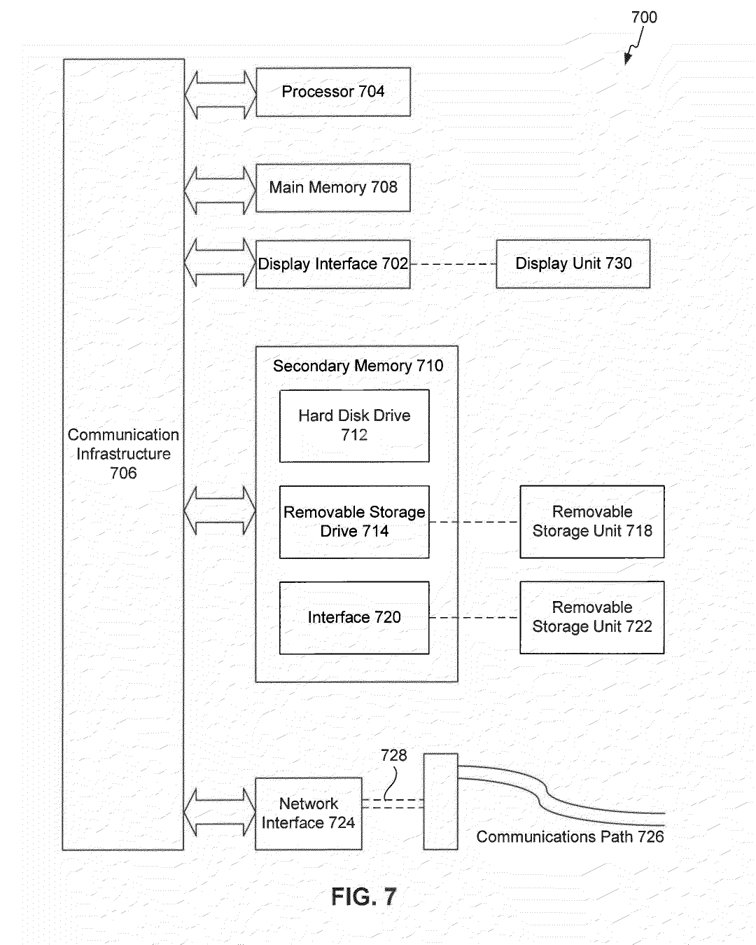

Various aspects of the present invention can be implemented by software, firmware, hardware, or a combination thereof. FIG. 7 illustrates an example computer system 700 in which the present invention, or portions thereof, can be implemented as computer-readable code. For example, the methods illustrated in FIGS. 1-6 can be implemented in system 700. Various embodiments of the invention are described in terms of this example computer system 700. After reading this description, it will become apparent to a person skilled in the relevant art how to implement the invention using other computer systems and/or computer architectures.

Computer system 700 includes one or more processors, such as processor 704. Processor 704 can be a special purpose or a general purpose processor. Processor 704 is connected to a communication infrastructure 706 (for example, a bus or network).

Computer system 700 also includes a main memory 708, preferably random access memory (RAM), and may also include a secondary memory 710. Secondary memory 710 may include, for example, a hard disk drive 712, a removable storage drive 714, and/or a memory stick. Removable storage drive 714 may include a floppy disk drive, a magnetic tape drive, an optical disk drive, a flash memory, or the like. The removable storage drive 714 reads from and/or writes to a removable storage unit 718 in a well-known manner. Removable storage unit 718 may include a floppy disk, magnetic tape, optical disk, etc. that is read by and written to by removable storage drive 714. As will be appreciated by persons skilled in the relevant art(s), removable storage unit 718 includes a computer usable storage medium having stored therein computer software and/or data.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 that allow software and data to be transferred from the removable storage unit 722 to computer system 700.

Computer system 700 may also include a communications interface 724. Communications interface 724 allows software and data to be transferred between computer system 700 and external devices. Communications interface 724 may include a modem, a network interface (such as an Ethernet card), a communications port, a PCMCIA slot and card, or the like. Software and data transferred via communications interface 724 are in the form of non-storage signals that may be electronic, electromagnetic, optical, or other signals capable of being received by communications interface 724. These signals are provided to communications interface 724 via a communications path 726. Communications path 726 carries signals and may be implemented using wire or cable, fiber optics, a phone line, a cellular phone link, an RF link or other communications channels.

In this document, the terms “computer readable storage medium” and “computer usable storage medium” are used to generally refer to storage media such as removable storage unit 718, removable storage unit 722, and a hard disk installed in hard disk drive 712. Computer readable storage medium and computer usable storage medium can also refer to memories, such as main memory 708 and secondary memory 710, which can be memory semiconductors (e.g. DRAMs, etc.). These computer program products are means for providing software to computer system 700.

Computer programs (also called computer control logic) are stored in main memory 708 and/or secondary memory 710. Computer programs may also be received via communications interface 724. Such computer programs, when executed, enable computer system 700 to implement embodiments of the present invention as discussed herein. In particular, the computer programs, when executed, enable processor 704 to implement the processes of the present invention, such as the steps in the methods illustrated by FIGS. 1-6, discussed above. Accordingly, such computer programs represent controllers of the computer system 700. Where the invention is implemented using software, the software may be stored in a computer program product and loaded into computer system 700 using removable storage drive 714, interface 720, hard drive 712 or communications interface 724.

Embodiments of the invention are also directed to computer program products including software stored on any computer useable medium. Such software, when executed in one or more data processing device, causes a data processing device(s) to operate as described herein. Embodiments of the invention employ any computer useable or readable medium, known now or in the future. Examples of computer readable storage mediums include, but are not limited to, primary storage devices (e.g., any type of random access memory) and secondary storage devices (e.g., hard drives, floppy disks, CD ROMS, ZIP disks, tapes, magnetic storage devices, optical storage devices, MEMS, nanotechnological storage device, etc.). Examples of non-storage mediums include communication mediums (e.g., wired and wireless communications networks, local area networks, wide area networks, intranets, etc.).

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A method comprising:
delivering, by one or more computing devices, a fixed rate exchangeable sovereign debt instrument to a sovereign in exchange for receiving a floating rate exchangeable sovereign debt instrument from the sovereign, wherein the exchange is performed by the one or more computing devices and specifies that the sovereign is to make floating rate interest payments to the holder of the floating rate exchangeable sovereign debt instrument; and
executing, by the one or more computing devices, an interest rate swap with the sovereign, wherein the interest rate swap specifies that payment is made to the sovereign of the floating rate interest payments of the floating rate exchangeable sovereign debt instrument and that payment is received from the sovereign of fixed rate interest payments of the fixed rate exchangeable sovereign debt instrument.

2. The method of claim 1, further comprising:
tendering an exchange price to the sovereign based on the difference in value between the floating rate exchangeable sovereign debt instrument and the fixed rate exchangeable sovereign debt instrument.

3. The method of claim 1, further comprising:
purchasing the fixed rate exchangeable sovereign debt instrument; and
selling the floating rate exchangeable sovereign debt instrument.

4. The method of claim 1, wherein a rate of the floating rate interest payments is based on an interest rate benchmark.

5. The method of claim 1, wherein contracting the interest rate swap with the sovereign is performed through a central counterparty, wherein the central counterparty is a counterparty to a dealer and the sovereign.

6. The method of claim 1, wherein delivering the fixed rate exchangeable sovereign debt instrument to the sovereign in exchange for receiving the floating rate exchangeable sovereign debt instrument from the sovereign happens substantially concurrently.

7. A computer-readable medium having instructions stored thereon, execution of which, by a computing device, causes the computing device to perform operations comprising:
delivering a fixed rate exchangeable sovereign debt instrument to a sovereign in exchange for receiving a floating rate exchangeable sovereign debt instrument from the sovereign, wherein the exchange is performed by the one or more computing devices and specifies that the sovereign is to make floating rate interest payments to the holder of the floating rate exchangeable sovereign debt instrument; and
executing an interest rate swap with the sovereign, wherein the interest rate swap specifies that payment is made to the sovereign of the floating rate interest payments of the floating rate exchangeable sovereign debt instrument and that payment is received from the sovereign of fixed rate interest payments of the fixed rate exchangeable sovereign debt instrument.

8. The computer-readable medium of claim 7, the operations further comprising:
tendering an exchange price to the sovereign based on the difference in value between the floating rate exchangeable sovereign debt instrument and the fixed rate exchangeable sovereign debt instrument.

9. The computer-readable medium of claim 7, the operations further comprising:
purchasing the fixed rate exchangeable sovereign debt instrument; and
selling the floating rate exchangeable sovereign debt instrument.

10. The computer-readable medium of claim 7, wherein a rate of the floating rate interest payments is based on an interest rate benchmark.

11. The computer-readable medium of claim 7, wherein contracting the interest rate swap with the sovereign is performed through a central counterparty, wherein the central counterparty is a counterparty to a dealer and the sovereign.

12. The computer-readable medium of claim 7, wherein delivering the fixed rate exchangeable sovereign debt instrument to the sovereign in exchange for receiving the floating rate exchangeable sovereign debt instrument from the sovereign happens substantially concurrently.

13. A system comprising:
one or more memory devices configured to store modules comprising:
a delivering module configured to deliver a fixed rate exchangeable sovereign debt instrument to a sovereign in exchange for receiving a floating rate exchangeable sovereign debt instrument from the sovereign, wherein the exchange is performed by the one or more computing devices and specifies that the sovereign is to make floating rate interest payments to the holder of the floating rate exchangeable sovereign debt instrument, and
an executing module configured to execute an interest rate swap with the sovereign, wherein the interest rate swap specifies that payment is made to the sovereign of the floating rate interest payments of the floating rate exchangeable sovereign debt instrument and that payment is received from the sovereign of fixed rate interest payments of the fixed rate exchangeable sovereign debt instrument; and
one or more processing devices configured to process the modules.

14. The system of claim 13, further comprising:
a tendering module configured to tender an exchange price to the sovereign based on the difference in value between the floating rate exchangeable sovereign debt instrument and the fixed rate exchangeable sovereign debt instrument.

15. The system of claim 13, further comprising:
a purchasing module configured to purchase the fixed rate exchangeable sovereign debt instrument; and
a selling module configured to sell the floating rate exchangeable sovereign debt instrument.

16. The system of claim 13, wherein a rate of the floating rate interest payments is based on an interest rate benchmark.

17. The system of claim 13, wherein contracting the interest rate swap with the sovereign is performed through a central counterparty, wherein the central counterparty is a counterparty to a dealer and the sovereign.

18. The system of claim 13, Wherein delivering the fixed rate exchangeable sovereign debt instrument to the sovereign in exchange for receiving the floating rate exchangeable sovereign debt instrument from the sovereign happens substantially concurrently.
